(19) United States
(12) Patent Application Publication
(10) Pub. No.: US 2026/0024228 A1
(43) Pub. Date: Jan. 22, 2026

(54) SYSTEM AND METHOD FOR DETERMINING A PITCH ANGLE OF A CAMERA IN A VEHICLE

(71) Applicant: GM Global Technology Operations LLC, Detroit, MI (US)

(72) Inventors: Hussein Berry, Dearborn, MI (US); Hector Salvador Montanez Alvarez, Bingham Farms, MI (US); Joshua Michael Martin, White Lake, MI (US)

(21) Appl. No.: 18/779,468

(22) Filed: Jul. 22, 2024

(51) Int. Cl. G06T 7/73; G06T 5/70; G06T 7/00; G06T 7/13; G06T 7/70; G06T 7/80

(52) U.S. Cl. CPC G06T 7/74; G06T 5/70; G06T 7/001; G06T 7/13; G06T 7/70; G06T 7/80; G06T 2207/10024

(57) ABSTRACT

A method for determining the pitch angle of a camera in a vehicle includes importing the image from the camera into a controller and determining the center of the point of reference in the image. The center of the point of reference in the image has a pixel position. The method includes converting the pixel position into a determined pitch angle of the camera. The method includes determining whether the determined pitch angle of the camera is equal to a predetermined pitch angle. The method includes rotating the camera relative to the vehicle body until the determined pitch angle is equal to the predetermined pitch angle in response to determining that the determined pitch angle of the camera is not equal to the predetermined pitch angle.

### INTRODUCTION

The present disclosure generally relates to system and methods for determining the pitch angle of a camera in a vehicle.

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

During vehicle manufacturing, the pitch angle of the cameras coupled to the vehicle should be determined to make sure that the cameras have the desired field of view. Current manufacturing methods use external sensors or markers and physically measure the pitch angle of the cameras using laser scans and/or a coordinate measurement machine. It is desirable, however, to develop a method for determining the pitch angle without using external sensors.

### SUMMARY

The present disclosure describes a method for determining the pitch angle of a camera in a vehicle. The method includes positioning the camera of the vehicle to capture an image of a point of reference while the vehicle or assembly remains stationary. The vehicle includes a vehicle body. The camera is movably coupled to the vehicle body. The method includes capturing the image with the camera of the vehicle that includes the point of reference while the vehicle remains stationary. The method also includes importing the image from the camera into a controller. The controller includes a processor and a non-transitory computer readable media in communication with the processor. The method includes determining the center of the point of reference in the image. The center of the point of reference in the image has a pixel position. The method involves converting the pixel position into a specified pitch angle of the camera. It includes checking if this calculated pitch angle matches a predefined pitch angle. If the calculated pitch angle does not match the predefined pitch angle, the method involves adjusting the camera's orientation relative to the vehicle body until the calculated pitch angle equals the predefined pitch angle. The method described in this paragraph improves vehicle manufacturing technology by determining the pitch angle of a camera in a vehicle without using external sensors and solely relying on the raw image captured by the camera.

The method may include transforming the image from a blue-green-red (BGR) color space into a gray color space after importing the image from the camera into the controller. The method may include blurring the image after transforming the image from the BGR color space into the gray color space. A Gaussian blur may be used to blur the image. The method may include detecting a plurality of edges of the image after blurring the image. A canny edge detector is used to detect the plurality of edges of the image. The method may include detecting a plurality of contours of the point of reference after detecting the edges of the image. The point of reference is a white rectangular plate. The method may include finding the center of the white rectangular plate in the image. The method may include determining the pixel position corresponding to the center of the white rectangular plate in the image. The method involves calculating the pitch angle by transforming pixel density and pixel position to determine the camera's rotation. Specifically, it transforms the pixel position corresponding to the center of the white rectangular plate into the determined pitch angle of the vehicle's camera.

The present disclosure also describes a system or method for determining the pitch angle of a camera in a vehicle. The system includes one or more cameras and a controller in communication with the camera. The controller is programmed to execute the method described above.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the presently disclosed system and method are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is a schematic diagram of a vehicle including a camera.

FIG. 2 is a flowchart of a method for determining the pitch angle of the camera in the vehicle.

### DETAILED DESCRIPTION

Reference will now be made in detail to several examples of the disclosure that are illustrated in the accompanying drawings. Whenever possible, the same or similar reference numerals are used in the drawings and the description to refer to the same or like parts or steps.

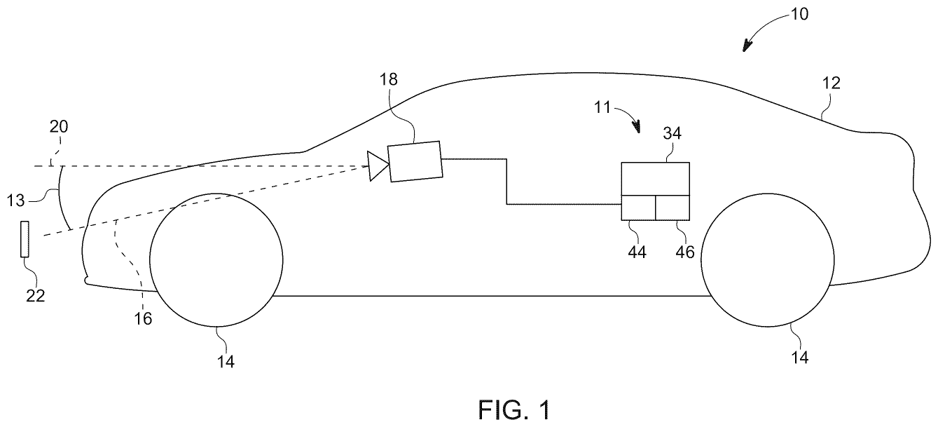

With reference to FIG. 1, a vehicle 10 generally includes a vehicle body 12 and a plurality of wheels 14 coupled to the vehicle body 12. The vehicle 10 may be an autonomous vehicle. The vehicle 10 may be a sedan, a truck, a coupe, a sport utility vehicle (SUV), a recreational vehicle (RV). The vehicle 10 further includes a system 11 for determining a pitch angle 13 of one or more cameras 18 in the vehicle 10. The camera 18 is directly coupled to the vehicle body 12. The camera 18 defines an optical axis 16. The pitch angle 13 is defined from the optical axis 16 to a horizontal axis 20.

Further, the system 11 includes a controller 34 in communication with the camera 18. While the controller 34 is shown coupled to the vehicle 10, it is contemplated that the controller 34 may be external to the vehicle 10. The controller 34 is programmed to receive the raw image from the camera 18 and includes at least one processor 44 and a non-transitory computer readable storage device or media 46. The processor 44 may be a custom-made processor, a central processing unit (CPU), a graphics processing unit (GPU), an auxiliary processor among several processors associated with the controller 34, a semiconductor-based microprocessor (in the form of a microchip or chip set), a macroprocessor, a combination thereof, or generally a device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media of the controller 34 may be implemented using a number of memory devices such as programmable read-only memory (PROMs), electrically PROM (EPROMs), electrically erasable PROM (EEPROMs), flash memory, or another electric, magnetic, optical, or combination memory devices capable of storing data, some of which represent executable instructions, used by the controller 34 in controlling the camera 18.

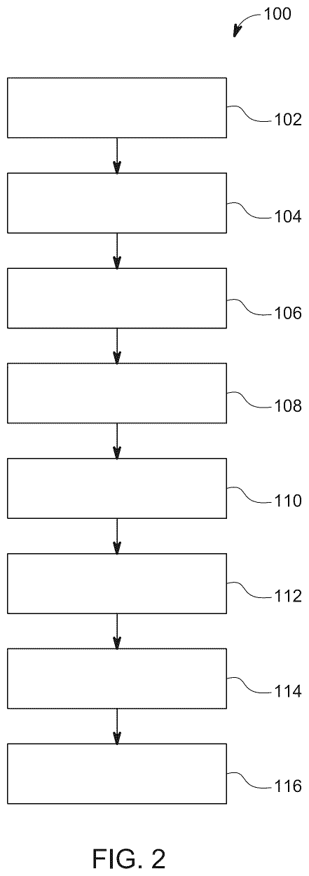

The instructions may include one or more separate programs, each of which comprises an ordered listing of executable instructions for implementing logical functions. The instructions, when executed by the processor 44, receive and process signals from the camera 18, perform logic, calculations, methods and/or algorithms for automatically controlling the components of the camera 18, and generate control signals based on the logic, calculations, methods, and/or algorithms. Although a single controller 34 is shown in FIG. 1, the system 11 may include a plurality of controllers 34 that communicate over a suitable communication medium or a combination of communication mediums and that cooperate to process the sensor signals, perform logic, calculations, methods, and/or algorithms, and generate control signals to automatically control features of the system 11. The non-transitory computer readable storage device or media 46 includes machine-readable instructions (shown, for example, in FIG. 2), that when executed by the one or more processors, cause the processors 44 to execute the method 100 (FIG. 2).

FIG. 2 is a flowchart of a method 100 for determining the pitch angle 13 of the camera 18 in the vehicle 10 may be programmed using any suitable programming language, such as PYTHON. The method 100 begins at block 102. At block 102, the camera 18 of the vehicle 10 is positioned to capture an image (i.e., the raw image at this juncture) of a point of reference 22 while the vehicle 10 remains stationary. The point of reference 22 may be a white rectangular plate. Further, at block 102, an image is captured with the camera of the vehicle 10 while the vehicle remains stationary. This image includes the point of reference 22 and all scene details. Also, at block 102, the raw image captured by the camera 18 is imported into the controller 34. The raw image is stored on the non-transitory computer readable storage media 46. The method 100 then continues to block 104.

At block 104, the image is transformed from a Blue-Green-Red (BGR) color space (or another color space, such as the RGB color space) into a gray color space (i.e., gray scale), allowing the method 100 to focus on core features. As a non-limiting example, the COLOR_BFR2GRAY function of the OPENCV2 library may be used in PYTHON to transform the image from the BFR color space into a gray color space. Then, the method 100 continues to block 106.

At block 106, the image is blurred to refine the edges of the image, thereby enhancing clarity. A Gaussian blur may be used to blur the image. As a non-limiting example, the GAUSSIANBLUR function of the OPENCV2 library may be used in PYTHON to blur the image. The method 100 then continues to block 108.

At block 108, the edges of the image are detected to highlight the boundaries that define objects within the image. A canny edge detector may be used to detect the edges within the image. As a non-limiting example, the CANNY function of the OPENCV2 library may be used in PYTHON to detect the edges within the image. Then, the method 100 continues to block 110.

At block 110, the contours of the point of reference 22 (e.g., white rectangular plate) are detected. As a non-limiting example, the FINDCONTOURS function of the OPENCV2 library may be used in PYTHON to detect the contours of the point of reference 22 within the image. Then, the method 100 continues to block 112.

At block 112, the controller 34 determines the center of the point of reference 22 (e.g., white rectangular plate) in the image. The center of the point of reference 22 in the image has a pixel position and a pixel density. Then, the method 100 continues to block 114.

At block 114, the pixel position is stored in, for example, a CSV file (or another type of file) on the non-transitory computer readable storage media 46. Then, the method 100 continues to block 116.

At block 116, the pixel position is transformed into a pitch angle 13 (i.e., the determined pitch angle) of the camera 18. The pixel density of the center of the point of reference 22 may also be used to convert the pixel position into the pitch angle 13. At block 116, the controller 34 may determine whether the determined pitch angle 13 of the camera 18 is equal to (or within the tolerance of) a predetermined, desired pitch angle. If the determined pitch angle 13 of the camera 18 is not equal to (or within the tolerance of) a predetermined, desired pitch angle camera 18, then the camera is rotated relative to the vehicle body 12 until the determined pitch angle 13 is equal to (or within the tolerance of) the predetermined pitch angle.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the presently disclosed system and method that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

The drawings are in simplified form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the disclosure in any manner.

Embodiments of the present disclosure are described herein. It is to be understood, however, that the disclosed embodiments are merely examples and other embodiments can take various and alternative forms. The figures are not necessarily to scale; some features could be exaggerated or minimized to display details of particular components. Therefore, specific structural and functional details disclosed herein are not to be interpreted as limiting, but merely as a representative basis for teaching one skilled in the art to variously employ the presently disclosed system and method. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A method for determining a pitch angle of a camera in a vehicle, comprising:
positioning the camera of the vehicle to capture an image of a point of reference while the vehicle remains stationary, wherein the vehicle includes a vehicle body, and the camera is coupled to the vehicle body;
capturing the image with the camera of the vehicle that includes the point of reference while the vehicle remains stationary;
importing the image from the camera into a controller, wherein the controller includes a processor and a non-transitory computer readable media in communication with the processor;
determining a center of the point of reference in the image, wherein the center of the point of reference in the image has a pixel position, and the camera has a pixel density;
determining a determined pitch angle using the pixel position of the center of the point of reference and the pixel density of the camera;
determining whether the determined pitch angle of the camera is equal to a predetermined pitch angle; and
in response to determining that the determined pitch angle of the camera is not equal to the predetermined pitch angle, rotating the camera relative to the vehicle body until the determined pitch angle is equal to the predetermined pitch angle.

2. The method of claim 1, further comprising transforming the image from a Blue-Green-Red (BGR) color space into a gray color space after importing the image from the camera into the controller.

3. The method of claim 2, further comprising blurring the image after transforming the image from the BGR color space into the gray color space.

4. The method of claim 3, wherein a Gaussian blur is used to blur the image.

5. The method of claim 4, further comprising detecting a plurality of edges of the image after blurring the image.

6. The method of claim 5, wherein a Canny edge detector is used to detect the plurality of edges of the image.

7. The method of claim 6, further comprising detecting a plurality of contours of the point of reference after detecting the edges of the image.

8. The method of claim 7, wherein the point of reference is a white rectangular plate.

9. The method of claim 8, further comprising finding a center of the white rectangular plate in the image.

10. The method of claim 9, further comprising determining the pixel position corresponding to the center of the white rectangular plate in the image.

11. The method of claim 10, transforming the pixel position corresponding to the center of the white rectangular plate into the determined pitch angle of the camera of the vehicle.

12. A system for determining a pitch angle, comprising:
a camera configured to capture an image, wherein the camera is coupled to a vehicle body of a vehicle;
a controller in communication with the camera, wherein the controller includes a processor and a non-transitory computer readable media in communication with the processor, and the controller is programmed to:
capturing the image with the camera of the vehicle that includes a point of reference while the vehicle remains stationary;
receive the image from the camera;
determine a center of the point of reference in the image, wherein the center of the point of reference in the image has a pixel position; and
transform the pixel position into a determined pitch angle of the camera.

13. The system of claim 12, wherein the controller is further programmed to transform the image from a Blue-Green-Red (BGR) color space into a gray color space after importing the image from the camera into the controller.

14. The system of claim 13, wherein the controller is further programmed to blur the image after transforming the image from the BGR color space into the gray color space.

15. The system of claim 14, wherein a Gaussian blur is used to blur the image.

16. The system of claim 15, wherein the controller is further programmed to detect a plurality of edges of the image after blurring the image.

17. The system of claim 16, wherein a Canny edge detector is used to detect the plurality of edges of the image.

18. The system of claim 17, wherein the controller is further programmed to detect a plurality of contours of the point of reference after detecting the edges of the image.

19. A method for determining a pitch angle of a camera in a vehicle, comprising:
positioning the camera of the vehicle to capture an image of a point of reference while the vehicle remains stationary, wherein the vehicle includes a vehicle body, and the camera is coupled to the vehicle body;
capturing the image with the camera of the vehicle that includes the point of reference while the vehicle remains stationary, wherein the camera is movably coupled to a vehicle body of the vehicle;
importing the image from the camera into a controller, wherein the controller includes a processor and a non-transitory computer readable media in communication with the processor;
transforming the image from a Blue-Green-Red (BGR) color space into a gray color space after importing the image from the camera into the controller;
blurring the image after transforming the image from the BGR color space into the gray color space;
detecting a plurality of edges of the image after blurring the image;
detecting a plurality of contours of the point of reference after detecting the edges of the image;
detecting a plurality of contours of the point of reference after detecting the edges of the image;
determining a center of the point of reference in the image, wherein the center of the point of reference in the image has a pixel position, and the camera has a pixel density;
determining a determined pitch angle using the pixel position of the center of the point of reference and the pixel density of the camera;
determining whether the determined pitch angle of the camera is equal to a predetermined pitch angle; and
in response to determining that the determined pitch angle of the camera is not equal to the predetermined pitch angle, rotating the camera relative to the vehicle body until the determined pitch angle is equal to the predetermined pitch angle;
wherein a Gaussian blur is used to blur the image;
wherein a Canny edge detector is used to detect the plurality of edges of the image; and
wherein the point of reference is a white rectangular plate.

20. The method of claim 19, further comprising:
determining the pixel position corresponding to the center of the white rectangular plate in the image; and
transforming the pixel position corresponding to the center of the white rectangular plate into the determined pitch angle of the camera of the vehicle.
